(19) United States
(12) Patent Application Publication
(10) Pub. No.: US 2025/0252395 A1
(43) Pub. Date: Aug. 7, 2025

(54) COMPARTMENT DISPLAY METHOD, DELIVERY ROBOT, AND STORAGE MEDIUM

(71) Applicant: Beijing Youzhuju Network Technology Co., Ltd., Beijing (CN)

(72) Inventors: Linge ZHANG, Beijing (CN); Yin YIN, Beijing (CN)

(21) Appl. No.: 19/039,153

(22) Filed: Jan. 28, 2025

(30) Foreign Application Priority Data
Feb. 7, 2024 (CN) 202410175576.5

(51) Int. Cl. G06Q 10/087; B65G 1/137; G05D 1/667; G05D 105/28; G05D 107/70

(52) U.S. Cl. CPC G06Q 10/087; B65G 1/1373; G05D 1/667; G05D 2105/28; G05D 2107/70

(57) ABSTRACT

Embodiments of the present disclosure provide a compartment display method, a delivery robot, and a storage medium. The method includes: obtaining a picking order that is being executed by a delivery robot, determining a to-be-picked-item that corresponds to the picking order, and determining a to-be-used-compartment that corresponds to the to-be-picked-item; and displaying, in a preset display interface of the delivery robot, compartment position prompt information corresponding to an actual spatial position of the to-be-used-compartment.

### CROSS-REFERENCE TO RELATED APPLICATION(S)

The present disclosure claims priority of the Chinese Patent Application No. 202410175576.5 filed on Feb. 7, 2024, the disclosure of which is incorporated herein by reference in its entirety as part of the present application.

### TECHNICAL FIELD

Embodiments of the present disclosure relate to computer application technologies, and in particular, to a compartment display method, a delivery robot, and a storage medium.

### BACKGROUND

Delivery robots are used to complete delivery tasks in the fields of logistics and express delivery. The delivery robots typically utilize machine vision, artificial intelligence, and automation technologies to identify items, determine delivery routes, and perform picking tasks. Generally, a delivery robot is provided with a plurality of item storage compartments for storage of picked items.

In the related art, to facilitate distinguishing between different item storage compartments, a different compartment identifier may be set for each item storage compartment, such that the item storage compartment is determined through the compartment identifier displayed in a display interface of the delivery robot. However, compartment identifiers are customized by users or manufacturers of the delivery robots using different identifier setting rules. This requires that pickers who collaborate with the delivery robots be very familiar with the setting rules for various compartment identifiers. Once they get the setting rules wrong, they are likely to operate another item storage compartment by mistake, thus misplacing goods. Even if the wrong operation is detected and corrected in a timely manner, a waste of time is caused, which affects the efficiency of picking and delivery.

### SUMMARY

Embodiments of the present disclosure provide a compartment display method and apparatus, a delivery robot, and a storage medium, to improve the delivery efficiency of a delivery robot.

According to a first aspect, an embodiment of the present disclosure provides a compartment display method. The method includes:
obtaining a picking order that is being executed by a delivery robot, determining a to-be-picked-item that corresponds to the picking order, and determining, as a to-be-used-compartment, a goods storage compartment corresponding to the to-be-picked-item; and
displaying, in a preset display interface of the delivery robot, compartment position prompt information corresponding to an actual spatial position of the to-be-used-compartment.

According to a second aspect, an embodiment of the present disclosure further provides a compartment display apparatus. The apparatus includes:
a compartment determination module configured to obtain a picking order that is being executed by a delivery robot, determine a to-be-picked-item that corresponds to the picking order, and determine, as a to-be-used-compartment, a goods storage compartment corresponding to the to-be-picked-item; and
a compartment display module configured to display, in a preset display interface of the delivery robot, compartment position prompt information corresponding to an actual spatial position of the to-be-used-compartment.

According to a third aspect, an embodiment of the present disclosure further provides a delivery robot. The delivery robot includes:
one or more processors; and
a storage apparatus configured to store one or more programs, where
the one or more programs, when executed by the one or more processors, cause the one or more processors to implement the compartment display method according to any one of the embodiments of the present disclosure.

According to a fourth aspect, an embodiment of the present disclosure further provides a storage medium containing computer-executable instructions, where the computer-executable instructions, when executed by a computer processor, are used to perform the compartment display method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a compartment display method according to an embodiment of the present disclosure;

FIG. 2A is a schematic flowchart of another compartment display method according to an embodiment of the present disclosure;

FIG. 2B is a schematic diagram of an example of displaying a compartment distribution map in a preset display interface in the compartment display method of this embodiment of the present disclosure, according to an embodiment of the present disclosure;

FIG. 3A is a schematic diagram of a structure of a compartment display apparatus according to an embodiment of the present disclosure;

FIG. 3B is a schematic diagram of an example of displaying position description text in a preset display interface in the compartment display method of this embodiment of the present disclosure, according to an embodiment of the present disclosure;

FIG. 4 is a schematic diagram of a structure of a compartment display apparatus according to an embodiment of the present disclosure; and

FIG. 5 is a schematic diagram of a structure of a delivery robot according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

FIG. 1 is a schematic flowchart of a compartment display method according to an embodiment of the present disclosure. The embodiment of the present disclosure is applicable to a case where an object is deleted and the object is restored after deletion. The method may be performed by a compartment display apparatus, which may be implemented in the form of software and/or hardware, and optionally, by a delivery robot.

As shown in FIG. 1, the method in this embodiment may specifically include the following steps.

S110: Obtain a picking order that is being executed by a delivery robot, determine a to-be-picked-item that corresponds to the picking order, and determine, as a to-be-used-compartment, a goods storage compartment corresponding to the to-be-picked-item.

In this embodiment of the present disclosure, the delivery robot may be a delivery robot applied in a warehousing scenario, for example, a robot in a warehouse that walks between a plurality of shelves for transport of items. The delivery robot may have a plurality of item storage compartments provided thereon. The item storage compartment may be understood as a container for carrying the to-be-picked-item. The picking order may be understood as a process of picking, according to an order requirement, a required item from a shelf or another storage region in the warehouse and then delivering the item to a preset delivery location. It should be noted that one delivery robot may fulfill one or more picking orders. The to-be-picked-item may be understood as an item that is to be picked from the shelf or the another storage region and then placed in the goods storage compartment of the delivery robot. Each of the picking orders may include one or more items to be picked. The to-be-used-compartment is a goods storage compartment that is determined from among the plurality of goods storage compartments of the delivery robot to store the to-be-picked-item.

As mentioned above, there may be a plurality of picking orders that need to be fulfilled by the delivery robot, and each of the picking orders may involve a plurality of items. The picking order may be dispatched via a warehouse management system. The warehouse management system, as a core system of warehouse management, can track and record goods and order information in the warehouse in real time. In this embodiment of the present disclosure, each of the picking orders may be assigned one or more item storage compartments. Further, each of the item storage compartments may also be assigned one or more items.

In this embodiment of the present disclosure, the picking order that is being executed by the delivery robot may be obtained first, and then the to-be-picked-item that corresponds to the picking order may be determined according to a relative spatial position of the delivery robot and ashelf and items stored on the shelf. Then, the corresponding goods storage compartment for storing the to-be-picked-item is determined based on the picking order and the to-be-picked-item, so that a picker can perform a picking operation.

S120: Display, in a preset display interface of the delivery robot, compartment position prompt information corresponding to an actual spatial position of the to-be-used-compartment.

The preset display interface may be understood as a preset information display interface. The preset display interface of the delivery robot may be an information display interface provided on the delivery robot. It should be noted that a display size, a display position, and other information about the preset display interface may be set according to actual needs, which are not specifically limited herein. One or more types of information related to the delivery robot may be displayed in the preset display interface. The actual spatial position may be understood as a spatial position at which the to-be-used-compartment is arranged on the delivery robot. Specifically, the actual spatial position may be determined according to a relative position of the to-be-used-compartment and item storage compartments other than the to-be-used-compartment on the delivery robot. Alternatively, the actual spatial position may be determined according to a spatial arrangement position of the to-be-used-compartment on the delivery robot. The compartment position prompt information may be understood as information for prompting the actual spatial position of the to-be-used-compartment.

In this embodiment of the present disclosure, the compartment position prompt information corresponding to the actual spatial position of the to-be-used-compartment may be displayed in one or more manners. Optionally, the compartment position prompt information corresponding to the actual spatial position of the to-be-used-compartment is displayed in the form of text and/or graphics. For example, a compartment distribution map of the plurality of item storage compartments provided on the delivery robot may be displayed, and/or the compartment position prompt information corresponding to the actual spatial position of the to-be-used-compartment may be displayed in the form of text. The compartment distribution map may be a layout map of some or all of the plurality of item storage compartments provided on the delivery robot. Exemplarily, when the delivery robot has a plurality of layers of item storage compartments provided thereon, the plurality of layers of item storage compartments may be displayed in layers, or may be displayed as a three-dimensional model.

In the technical solution of this embodiment of the present disclosure, the work task of the delivery robot can be accurately obtained by obtaining the picking order that is being executed by the delivery robot, and the to-be-picked-item that corresponds to the picking order can be matched with a suitable goods storage compartment by determining the to-be-picked-item and determining, as the to-be-used-compartment, the goods storage compartment corresponding to the to-be-picked-item; and the compartment position prompt information corresponding to the actual spatial position of the to-be-used-compartment is displayed in the preset display interface of the delivery robot, which allows intuitive display of the actual spatial position of the to-be-used-compartment. This solves the technical problem in the related art that a compartment is likely to be operated by mistake because compartment locating heavily relies on human memory, realizingaccurate and rapid locating of the to-be-used-compartment, and thus improving the efficiency of picking and delivery.

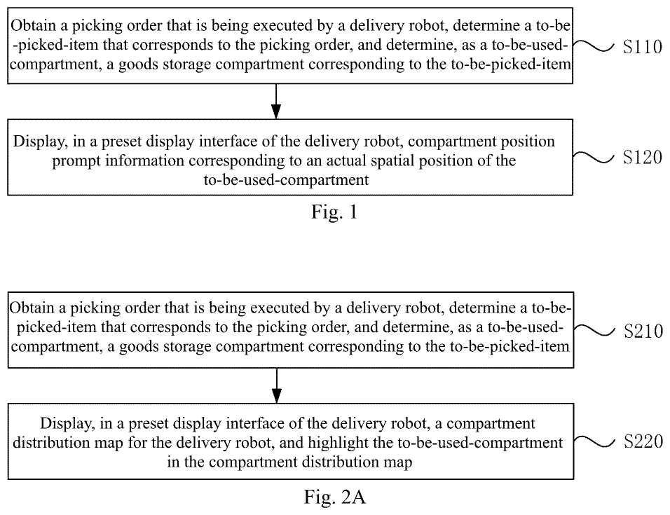

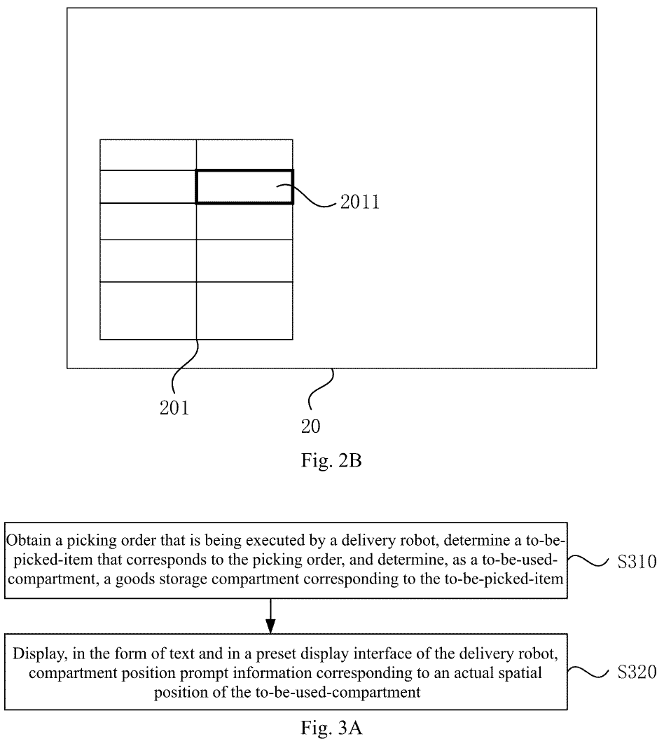

FIG. 2A is a schematic flowchart of another compartment display method according to an embodiment of the present disclosure. On the basis of the above embodiment, the technical solution of this embodiment further elaborates on the mode of prompting the actual spatial position of the to-be-used-compartment. Optionally, the displaying compartment position prompt information corresponding to an actual spatial position of the to-be-used-compartment includes: displaying a compartment distribution map for the delivery robot, and highlighting the to-be-used-compartment in the compartment distribution map, where the compartment distribution map includes a plurality of item storage compartments of the robot and a display position of each of the item storage compartments in the compartment distribution map corresponds to an actual spatial position of the item storage compartment. For a specific implementation, reference may be made to the description of this embodiment. Details about technical features that are the same as or similar to those in the foregoing embodiment are not repeated herein.

As shown in FIG. 2A, the method in this embodiment may specifically include the following steps.

S210: Obtain a picking order that is being executed by a delivery robot, determine a to-be-picked-item that corresponds to the picking order, and determine, as a to-be-used-compartment, a goods storage compartment corresponding to the to-be-picked-item.

S220: Display, in a preset display interface of the delivery robot, a compartment distribution map for the delivery robot, and highlight the to-be-used-compartment in the compartment distribution map.

The compartment distribution map may be understood as a schematic diagram for indicating the layout of a plurality of item storage compartments of the delivery robot. The compartment distribution map may be generated according to actual distribution information of the plurality of item storage compartments of the delivery robot. Specifically, the compartment distribution map includes the plurality of item storage compartments of the robot, and a display position of each of the item storage compartments in the compartment distribution map corresponds to an actual spatial position of the item storage compartment.

In order to facilitate identification of the to-be-used-compartment from among the plurality of item storage compartments of the delivery robot, the to-be-used-compartment may be highlighted in the compartment distribution map. Specifically, it may be understood that the to-be-used-compartment is displayed in the compartment distribution map in such a way that it is distinguished from the other item storage compartments. For example, the highlighting the to-be-used-compartment in the compartment distribution map includes at least one of the following operations: displaying the to-be-used-compartment in the compartment distribution map in a preset color; displaying a preset identifier at a preset position corresponding to the to-be-used-compartment in the compartment distribution map; displaying the to-be-used-compartment in the compartment distribution map in a preset form, where the preset form includes a preset shape and/or a preset size; and displaying the to-be-used-compartment in the compartment distribution map in a dynamic form, where the dynamic form includes a flashing form and/or a movement along a preset trajectory.

The preset color may be understood as a color that is set in advance. The preset color may be a fixed color or a combination of a plurality of colors. For example, in the compartment distribution map, the item storage compartments other than the to-be-used-compartment may be displayed in a first color, and the to-be-used-compartment may be displayed in a second color. The preset color may also be a dynamically changing color that is set in advance. For example, alternate display may be performed in two or more colors and according to a preset change sequence.

In an optional implementation of this embodiment of the present disclosure, the preset color can not only allow the to-be-used-compartment to be displayed in such a way that it is distinguished from the other item storage compartments in the compartment distribution map, but can also be associated with an item carrying status of the to-be-used-compartment. For example, in the compartment distribution map, the item storage compartments other than the to-be-used-compartment may be displayed in a first color. When the to-be-used-compartment has no item stored therein, the to-be-used-compartment may be displayed in a second color. When the to-be-used-compartment has an item stored therein but an item carrying capacity does not reach a preset carrying capacity threshold, the to-be-used-compartment may be displayed in a third color. When the to-be-used-compartment has an item stored therein and an item carrying capacity reaches the preset carrying capacity threshold, the to-be-used-compartment may be displayed in a fourth color. When the to-be-used-compartment has an item stored therein and is in full load, the to-be-used-compartment may be displayed in a fifth color, and so on.

The preset position may be understood as a display position that is set in advance in the compartment distribution map and that corresponds to the to-be-used-compartment. The preset identifier may be understood as an identifier that is set in advance to indicate whether the item storage compartment is the to-be-used-compartment. Specifically, the preset identifier may be at a preset position in a display region of the to-be-used-compartment. For example, the preset identifier may be displayed at an upper left corner, a lower left corner, an upper right corner, a lower right corner, or a center position of the display region of the to-be-used-compartment. For example, the preset identifier may be an identifier that is set in advance in the form of text and/or patterns.

The preset form may be understood as a preset form in which the display region corresponding to the to-be-used-compartment and/or an edge line of the to-be-used-compartment is presented in the compartment distribution map. The preset shape may be a shape that is set in advance. The preset shape may be the shape of the compartment display region corresponding to the to-be-used-compartment, for example, a circle, an ellipse, a star, etc. The preset shape may also be the shape of the edge line of the to-be-used-compartment, such as a dotted line or a wavy line. The preset size may be the size of the to-be-used-compartment after being scaled up or down, or may be the thickness of a line used to identify the to-be-used-compartment.

Optionally, the displaying the to-be-used-compartment in the compartment distribution map in a preset form includes: transforming the shape of the to-be-used-compartment, and then displaying the to-be-used-compartment in the compartment distribution map; or scaling up or down the to-be-used-compartment, and then displaying the to-be-used-compartment in the compartment distribution map; or displaying the to-be-used-compartment in the compartment distribution map by making an edge of the to-be-used-compartment bold, etc.

As shown in FIG. 2B, a compartment distribution map 201 may be displayed in a preset display interface 20 of the delivery robot. In the compartment distribution map 201, an edge of a compartment 2011 to be used may be displayed in bold or in a preset color to distinguish the to-be-used-compartment from the other item storage compartments.

The dynamic form may be understood as a changing display mode that is set in advance. Optionally, the displaying the to-be-used-compartment in the compartment distribution map in a dynamic form includes: displaying the to-be-used-compartment in the compartment distribution map by means of reciprocating motion such as up-and-down movement or left-and-right movement; or displaying an edge of the to-be-used-compartment in the compartment distribution map with a flashing effect to-be-used-compartment, etc.

In the technical solution of this embodiment of the present disclosure, the compartment distribution map for the delivery robot is displayed in the preset display interface of the delivery robot, which allows visual display of the spatial arrangement information of the plurality of item storage compartments of the delivery robot; further, the to-be-used-compartment is highlighted in the compartment distribution map, which allows intuitive and apparent display of the actual spatial position of the to-be-used-compartment, thereby realizing rapid locating of the to-be-used-compartment.

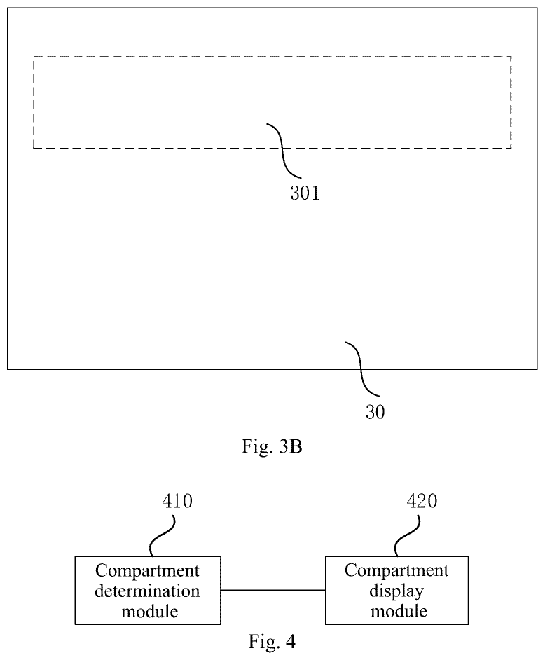

FIG. 3A is a schematic flowchart of another compartment display method according to an embodiment of the present disclosure. On the basis of the above embodiment, the technical solution of this embodiment further elaborates on the mode of prompting the actual spatial position of the to-be-used-compartment. Optionally, the displaying compartment position prompt information corresponding to an actual spatial position of the to-be-used-compartment specifically includes: displaying, in the form of text, the compartment position prompt information corresponding to the actual spatial position of the to-be-used-compartment. For a specific implementation, reference may be made to the description of this embodiment. Details about technical features that are the same as or similar to those in the foregoing embodiment are not repeated herein.

As shown in FIG. 3A, the method in this embodiment may specifically include the following steps.

S310: Obtain a picking order that is being executed by a delivery robot, determine a to-be-picked-item that corresponds to the picking order, and determine, as a to-be-used-compartment, a goods storage compartment corresponding to the to-be-picked-item.

S320. Display, in the form of text and in a preset display interface of the delivery robot, compartment position prompt information corresponding to an actual spatial position of the to-be-used-compartment.

In this embodiment of the present disclosure, considering that the delivery robot may have a limited display space and that other information may also need to be displayed in the preset display interface of the delivery robot, the compartment position prompt information may be displayed in the form of text, which is not only highly readable, intuitive, and easy to view, but can also effectively reduce the display space occupied in the preset display interface. The form of text may be understood as a form of text description.

As shown in FIG. 3B, a text display region 301 may be set in a preset display interface 30 of the delivery robot, so that the compartment position prompt information is displayed in the text display region 301 in the form of text. It may be understood that the text display region 301 may be set at any position in the preset display interface 30. The preset display interface 30 may be set at any position of the delivery robot. The position of the preset display interface 30 in the delivery robot and the position of the text display region 301 in the preset display interface 30 are not limited herein.

Optionally, the displaying, in the form of text, the compartment position prompt information corresponding to the actual spatial position of the to-be-used-compartment specifically includes: obtaining a compartment identifier corresponding to the to-be-used-compartment, obtaining, based on the compartment identifier, pre-stored position description text corresponding to the actual spatial position of the to-be-used-compartment, and displaying the position description text as the compartment position prompt information. This technical solution makes it possible to easily and quickly obtain, through the compartment identifier corresponding to the to-be-used-compartment, the position description text corresponding to the actual spatial position of the to-be-used-compartment, and then display the position description text, thereby improving the text display efficiency for the actual spatial position of the to-be-used-compartment.

The compartment identifier may be understood as an identifier for distinguishing different item storage compartments. For example, the compartment identifier may be identification information corresponding to the item storage compartment. Specifically, the compartment identifier may be identification information composed of a preset character. Further, the preset character may include at least one of a number, a letter, a word, and a symbol. The position description text may be understood as text information used to describe the actual spatial position of the to-be-used-compartment.

Exemplarily, the position description text includes orientation information and/or sorting information, etc. The orientation information may be understood as information indicating a direction and/or an angle of the to-be-used-compartment, for example, an upper left corner, a lower left corner, an upper right corner, a lower right corner, from top to bottom, from bottom to top, from left to right, etc. The orientation information may assist a user in determining the relative position and direction of the to-be-used-compartment, so that they can more accurately locate and operate the to-be-used-compartment. The sorting information may be understood as a relative arrangement position of the to-be-used-compartment in the plurality of item storage compartments. Exemplarily, the sorting information may be thenthone in the mthrow, etc. Considering that the delivery robot often has a plurality of item storage compartments or even a plurality of layers of item storage compartments provided therein, the actual spatial position of the to-be-used-compartment may be described by using the orientation information in combination with the sorting information. For example, specifically, the actual spatial position of the to-be-used-compartment may be described as the second item storage compartment from the left in the first row from top to bottom, in the case of facing the delivery robot, etc.

As an optional implementation of this embodiment of the present disclosure, before the obtaining, based on the compartment identifier, pre-stored position description text corresponding to the actual spatial position of the to-be-used-compartment, the method further includes: obtaining compartment layout information of a plurality of item storage compartments of the delivery robot, and determining, based on the compartment layout information, position description text corresponding to an actual spatial position of each of the item storage compartments; and storing the position description text corresponding to each of the item storage compartments in correspondence with a compartment identifier of the item storage compartment. Because delivery robots that are put into use have relatively fixed settings for their item storage compartments, this technical solution allows the position description text to be generated in advance, and the position prompt information for the to-be-used-compartment to be quickly obtained and displayed in need of displaying the position prompt information, thereby improving the display efficiency of the compartment position prompt information. Moreover, the compartment identifier of each item storage compartment is stored in correspondence with the position description text for the item storage compartment, which ensures the accuracy and convenience of obtaining the position description text.

The compartment layout information may be understood as position distribution information of the plurality of item storage compartments in the delivery robot. For example, the plurality of item storage compartments may be arranged in a single-row and multi-column mode, a multi-row and single-column mode, or a multi-row and multi-column mode, or may be arranged in a preset shape (such as a circle, a star, or a heart).

It may be understood that the compartment layout information of the plurality of item storage compartments of the delivery robot is associated with a structural design of the delivery robot, and different delivery robots may have the same or different compartment layout information for a plurality of item storage compartments.

Optionally, the determining, based on the compartment layout information, position description text corresponding to an actual spatial position of each of the item storage compartments may specifically include: determining, based on the compartment layout information, relative position information of each of the item storage compartments and the other item storage compartments; and then generating, based on the relative position information corresponding to each of the item storage compartments, the position description text corresponding to the actual spatial position of the item storage compartment. With this technical solution, the actual spatial position corresponding to the to-be-used-compartment can be clearly described by using the distribution information of the plurality of item storage compartments of the delivery robot as a reference, which is convenient for a user to identify and operate.

The relative position information may be understood as position information determined from spatial arrangement positions of the other item storage compartments. Similarly, the relative position information may also include orientation information and/or sorting information, etc. For example, the relative position information may be left, right, layer number, ordinal number, etc. Exemplarily, after the compartment layout information of the plurality of item storage compartments of the delivery robot is obtained, the identifier and relative position information of each of the item storage compartments may be determined one by one based on the spatial arrangement position of each of the item storage compartments in the compartment layout information. For example, the determination process may be specifically: determining, as a starting compartment, the item storage compartment located at a starting position in the compartment layout information, separately numbering, staring from the starting compartment, the item storage compartments according to a preset numbering method as compartment identifiers of the item storage compartments, and determining the relative position information of the item storage compartments according to the spatial arrangement positions thereof. For each of the item storage compartments, position description text corresponding thereto is stored in correspondence with the compartment identifier thereof to facilitate a query by a user.

In the technical solution of this embodiment of the present disclosure, the compartment position prompt information corresponding to the actual spatial position of the to-be-used-compartment is displayed in the form of text in the preset display interface of the delivery robot, which increases readability, allows intuitive and accurate indication of the actual spatial position of the to-be-used-compartment, and thus makes the display mode of the actual spatial position of the to-be-used-compartment clearer and easier to understand, so as to realize rapid and accurate picking. In addition, the description in the form of text is also easy to read and understand, which facilitates further use and management of the compartment position prompt information.

FIG. 4 is a schematic diagram of a structure of a compartment display apparatus according to an embodiment of the present disclosure. As shown in FIG. 4, the apparatus includes a compartment determination module 410 and a compartment display module 420. The compartment determination module 410 is configured to obtain a picking order that is being executed by a delivery robot, determine a to-be-picked-item that corresponds to the picking order, and determine, as a to-be-used-compartment, a goods storage compartment corresponding to the to-be-picked-item. The compartment display module 420 is configured to display, in a preset display interface of the delivery robot, compartment position prompt information corresponding to an actual spatial position of the to-be-used-compartment.

In the technical solution of this embodiment of the present disclosure, the compartment determination module is used to obtain the picking order that is being executed by the delivery robot, determine the to-be-picked-item that corresponds to the picking order, and determine, as the to-be-used-compartment, the goods storage compartment corresponding to the to-be-picked-item, such that the work task of the delivery robot can be accurately obtained, and the to-be-picked-item can be matched with a suitable goods storage compartment; and the compartment display module is configured to display, in the preset display interface of the delivery robot, the compartment position prompt information corresponding to the actual spatial position of the to-be-used-compartment, which allows intuitive display of the actual spatial position of the to-be-used-compartment. This solves the technical problem in the related art that a compartment is likely to be operated by mistake because compartment locating heavily relies on human memory, realizing accurate and rapid locating of the to-be-used-compartment, and thus improving the efficiency of picking and delivery.

On the basis of the above optional technical solutions, optionally, the compartment display module 420 includes a distribution map display unit, where the distribution map display unit is configured to display a compartment distribution map for the delivery robot, and highlight the to-be-used-compartment in the compartment distribution map, where the compartment distribution map includes a plurality of item storage compartments of the robot and a display position of each of the item storage compartments in the compartment distribution map corresponds to an actual spatial position of the item storage compartment.

On the basis of the above optional technical solutions, optionally, the distribution map display unit is configured to perform at least one of the following operations:
displaying the to-be-used-compartment in the compartment distribution map in a preset color;
displaying a preset identifier at a preset position corresponding to the to-be-used-compartment in the compartment distribution map;
displaying the to-be-used-compartment in the compartment distribution map in a preset form, where the preset form includes a preset shape and/or a preset size; and
displaying the to-be-used-compartment in the compartment distribution map in a dynamic form, where the dynamic form includes a flashing form and/or a movement along a preset trajectory.

On the basis of the above optional technical solutions, optionally, the compartment display module 420 includes a description text display unit, where the description text display unit is configured to display, in the form of text, the compartment position prompt information corresponding to the actual spatial position of the to-be-used-compartment.

On the basis of the above optional technical solutions, optionally, the description text display unit is specifically configured to obtain a compartment identifier corresponding to the to-be-used-compartment, obtain, based on the compartment identifier, pre-stored position description text corresponding to the actual spatial position of the to-be-used-compartment, and display the position description text as the compartment position prompt information.

On the basis of the above optional technical solutions, optionally, the compartment display apparatus further includes a description text determination module and a description text storage module. The description text determination module is configured to, before the obtaining, based on the compartment identifier, pre-stored position description text corresponding to the actual spatial position of the to-be-used-compartment, obtain compartment layout information of a plurality of item storage compartments of the delivery robot, and determine, based on the compartment layout information, position description text corresponding to an actual spatial position of each of the item storage compartments. The description text storage module is configured to store the position description text corresponding to each of the item storage compartments in correspondence with a compartment identifier of the item storage compartment.

On the basis of the above optional technical solutions, optionally, the description text determination module includes: a relative position determination unit and a description text generation unit. The relative position determination unit is configured to determine, based on the compartment layout information, relative position information of each of the item storage compartments and the other item storage compartments. The description text generation unit is configured to generate, based on the relative position information corresponding to each of the item storage compartments, the position description text corresponding to the actual spatial position of the item storage compartment.

On the basis of the above optional technical solutions, optionally, the position description text includes orientation information and/or sorting information.

The compartment display apparatus according to this embodiment of the present disclosure can perform the compartment display method according to any one of the embodiments of the present disclosure, and has corresponding functional modules and beneficial effects for performing the compartment display method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

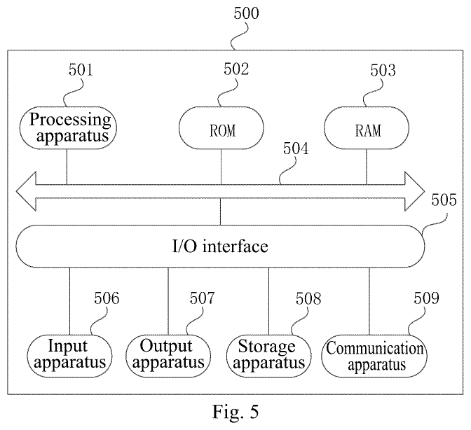

FIG. 5 is a schematic diagram of a structure of a delivery robot according to an embodiment of the present disclosure. Reference is made to FIG. 5 below, which is a schematic diagram of a structure of a delivery robot (such as a terminal device or a server in FIG. 5) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The delivery robot shown in FIG. 5 is merely an example, and shall not impose any limitation on the function and scope of use of the embodiments of the present disclosure.

As shown in FIG. 5, the delivery robot 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the delivery robot 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the delivery robot 500 to perform wireless or wired communication with other devices to exchange data. Although FIG. 5 shows the delivery robot 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the compartment display method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the compartment display method provided in the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: obtain a picking order that is being executed by a delivery robot, determine a to-be-picked-item that corresponds to the picking order, and determine, as a to-be-used-compartment, a goods storage compartment corresponding to the to-be-picked-item; and display, in a preset display interface of the delivery robot, compartment position prompt information corresponding to an actual spatial position of the to-be-used-compartment.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet Protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a compartment display method. The method includes: obtaining a picking order that is being executed by a delivery robot, determining a to-be-picked-item that corresponds to the picking order, and determining, as a to-be-used-compartment, a goods storage compartment corresponding to the to-be-picked-item; and displaying, in a preset display interface of the delivery robot, compartment position prompt information corresponding to an actual spatial position of the to-be-used-compartment.

According to one or more embodiments of the present disclosure, [Example 2] provides the method of Example 1, where optionally, the displaying compartment position prompt information corresponding to an actual spatial position of the to-be-used-compartment includes: displaying a compartment distribution map for the delivery robot, and highlighting the to-be-used-compartment in the compartment distribution map, where the compartment distribution map includes a plurality of item storage compartments of the robot and a display position of each of the item storage compartments in the compartment distribution map corresponds to an actual spatial position of the item storage compartment.

According to one or more embodiments of the present disclosure, [Example 3] provides the method of Example 2, where optionally, the highlighting the to-be-used-compartment in the compartment distribution map includes at least one of the following operations: displaying the to-be-used-compartment in the compartment distribution map in a preset color; displaying a preset identifier at a preset position corresponding to the to-be-used-compartment in the compartment distribution map; displaying the to-be-used-compartment in the compartment distribution map in a preset form, where the preset form includes a preset shape and/or a preset size; and displaying the to-be-used-compartment in the compartment distribution map in a dynamic form, where the dynamic form includes a flashing form and/or a movement along a preset trajectory.

According to one or more embodiments of the present disclosure, [Example 4] provides the method of Example 1, where optionally, the displaying compartment position prompt information corresponding to an actual spatial position of the to-be-used-compartment includes: displaying, in the form of text, the compartment position prompt information corresponding to the actual spatial position of the to-be-used-compartment.

According to one or more embodiments of the present disclosure, [Example 5] provides the method of Example 4, where optionally, the displaying, in the form of text, the compartment position prompt information corresponding to the actual spatial position of the to-be-used-compartment includes: obtaining a compartment identifier corresponding to the to-be-used-compartment, obtaining, based on the compartment identifier, pre-stored position description text corresponding to the actual spatial position of the to-be-used-compartment, and displaying the position description text as the compartment position prompt information.

According to one or more embodiments of the present disclosure, [Example 6] provides the method of Example 5, where optionally, before the obtaining, based on the compartment identifier, pre-stored position description text corresponding to the actual spatial position of the to-be-used-compartment, the method further includes: obtaining compartment layout information of a plurality of item storage compartments of the delivery robot, and determining, based on the compartment layout information, position description text corresponding to an actual spatial position of each of the item storage compartments; and storing the position description text corresponding to each of the item storage compartments in correspondence with a compartment identifier of the item storage compartment.

According to one or more embodiments of the present disclosure, [Example 7] provides the method of Example 6, where optionally, the determining, based on the compartment layout information, position description text corresponding to an actual spatial position of each of the item storage compartments includes: determining, based on the compartment layout information, relative position information of each of the item storage compartments and the other item storage compartments; and generating, based on the relative position information corresponding to each of the item storage compartments, the position description text corresponding to the actual spatial position of the item storage compartment.

According to one or more embodiments of the present disclosure, [Example 8] provides the method of Example 5, where optionally, the position description text includes orientation information and/or sorting information.

According to one or more embodiments of the present disclosure, [Example 9] provides a compartment display apparatus. The apparatus includes: a compartment determination module configured to obtain a picking order that is being executed by a delivery robot, determine a to-be-picked-item that corresponds to the picking order, and determine, as a to-be-used-compartment, a goods storage compartment corresponding to the to-be-picked-item; and a compartment display module configured to display, in a preset display interface of the delivery robot, compartment position prompt information corresponding to an actual spatial position of the to-be-used-compartment.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. Instead, the specific features and actions described above are merely exemplary forms of implementing the claims.

1. A compartment display method, comprising:
obtaining a picking order that is being executed by a delivery robot, determining a to-be-picked-item that corresponds to the picking order, and determining, as a to-be-used-compartment, a goods storage compartment corresponding to the to-be-picked-item; and
displaying, in a preset display interface of the delivery robot, compartment position prompt information corresponding to an actual spatial position of the to-be-used-compartment.

2. The compartment display method according to claim 1, wherein the displaying compartment position prompt information corresponding to an actual spatial position of the to-be-used-compartment comprises:
displaying a compartment distribution map for the delivery robot, and highlighting the to-be-used-compartment in the compartment distribution map, wherein the compartment distribution map comprises a plurality of item storage compartments of the robot and a display position of each of the item storage compartments in the compartment distribution map corresponds to an actual spatial position of the item storage compartment.

3. The compartment display method according to claim 2, wherein the highlighting the to-be-used-compartment in the compartment distribution map comprises at least one of the following operations:
displaying the to-be-used-compartment in the compartment distribution map in a preset color;
displaying a preset identifier at a preset position corresponding to the to-be-used-compartment in the compartment distribution map;
displaying the to-be-used-compartment in the compartment distribution map in a preset form, wherein the preset form comprises a preset shape and/or a preset size; and
displaying the to-be-used-compartment in the compartment distribution map in a dynamic form, wherein the dynamic form comprises a flashing form and/or a movement along a preset trajectory.

4. The compartment display method according to claim 1, wherein the displaying compartment position prompt information corresponding to an actual spatial position of the to-be-used-compartment comprises:
displaying, in the form of text, the compartment position prompt information corresponding to the actual spatial position of the to-be-used-compartment.

5. The compartment display method according to claim 4, wherein the displaying, in the form of text, the compartment position prompt information corresponding to the actual spatial position of the to-be-used-compartment comprises:
obtaining a compartment identifier corresponding to the to-be-used-compartment, obtaining, based on the compartment identifier, pre-stored position description text corresponding to the actual spatial position of the to-be-used-compartment, and displaying the position description text as the compartment position prompt information.

6. The compartment display method according to claim 5, wherein before the obtaining, based on the compartment identifier, pre-stored position description text corresponding to the actual spatial position of the to-be-used-compartment, the method further comprises:
obtaining compartment layout information of a plurality of item storage compartments of the delivery robot, and determining, based on the compartment layout information, position description text corresponding to an actual spatial position of each of the item storage compartments; and
storing the position description text corresponding to each of the item storage compartments in correspondence with a compartment identifier of the item storage compartment.

7. The compartment display method according to claim 6, wherein the determining, based on the compartment layout information, position description text corresponding to an actual spatial position of each of the item storage compartments comprises:
determining, based on the compartment layout information, relative position information of each of the item storage compartments and the other item storage compartments; and
generating, based on the relative position information corresponding to each of the item storage compartments, the position description text corresponding to the actual spatial position of the item storage compartment.

8. The compartment display method according to claim 5, wherein the position description text comprises orientation information and/or sorting information.

9. A delivery robot, comprising:
one or more processors; and
a storage apparatus configured to store one or more programs, wherein
the one or more programs, when executed by the one or more processors, cause the one or more processors to implement a compartment display method,
the method comprises:
obtaining a picking order that is being executed by a delivery robot, determining a to-be-picked-item that corresponds to the picking order, and determining, as a to-be-used-compartment, a goods storage compartment corresponding to the to-be-picked-item; and
displaying, in a preset display interface of the delivery robot, compartment position prompt information corresponding to an actual spatial position of the to-be-used-compartment.

10. The delivery robot according to claim 9, wherein the displaying compartment position prompt information corresponding to an actual spatial position of the to-be-used-compartment comprises:
displaying a compartment distribution map for the delivery robot, and highlighting the to-be-used-compartment in the compartment distribution map, wherein the compartment distribution map comprises a plurality of item storage compartments of the robot and a display position of each of the item storage compartments in the compartment distribution map corresponds to an actual spatial position of the item storage compartment.

11. The delivery robot according to claim 10, wherein the highlighting the to-be-used-compartment in the compartment distribution map comprises at least one of the following operations:
displaying the to-be-used-compartment in the compartment distribution map in a preset color;
displaying a preset identifier at a preset position corresponding to the to-be-used-compartment in the compartment distribution map;
displaying the to-be-used-compartment in the compartment distribution map in a preset form, wherein the preset form comprises a preset shape and/or a preset size; and
displaying the to-be-used-compartment in the compartment distribution map in a dynamic form, wherein the dynamic form comprises a flashing form and/or a movement along a preset trajectory.

12. The delivery robot according to claim 9, wherein the displaying compartment position prompt information corresponding to an actual spatial position of the to-be-used-compartment comprises:
displaying, in the form of text, the compartment position prompt information corresponding to the actual spatial position of the to-be-used-compartment.

13. The delivery robot according to claim 12, wherein the displaying, in the form of text, the compartment position prompt information corresponding to the actual spatial position of the to-be-used-compartment comprises:
obtaining a compartment identifier corresponding to the to-be-used-compartment, obtaining, based on the compartment identifier, pre-stored position description text corresponding to the actual spatial position of the to-be-used-compartment, and displaying the position description text as the compartment position prompt information.

14. The delivery robot according to claim 13, wherein before the obtaining, based on the compartment identifier, pre-stored position description text corresponding to the actual spatial position of the to-be-used-compartment, the one or more processors is further caused to:
obtaining compartment layout information of a plurality of item storage compartments of the delivery robot, and determining, based on the compartment layout information, position description text corresponding to an actual spatial position of each of the item storage compartments; and
storing the position description text corresponding to each of the item storage compartments in correspondence with a compartment identifier of the item storage compartment.

15. The delivery robot according to claim 14, wherein the determining, based on the compartment layout information, position description text corresponding to an actual spatial position of each of the item storage compartments comprises:
determining, based on the compartment layout information, relative position information of each of the item storage compartments and the other item storage compartments; and
generating, based on the relative position information corresponding to each of the item storage compartments, the position description text corresponding to the actual spatial position of the item storage compartment.

16. The delivery robot according to claim 13, wherein the position description text comprises orientation information and/or sorting information.

17. A storage medium comprising computer-executable instructions, wherein the computer-executable instructions, when executed by a computer processor, are used to perform a compartment display method,
the method comprises:
obtaining a picking order that is being executed by a delivery robot, determining a to-be-picked-item that corresponds to the picking order, and determining, as a to-be-used-compartment, a goods storage compartment corresponding to the to-be-picked-item; and
displaying, in a preset display interface of the delivery robot, compartment position prompt information corresponding to an actual spatial position of the to-be-used-compartment.

18. The storage medium according to claim 17, wherein the displaying compartment position prompt information corresponding to an actual spatial position of the to-be-used-compartment comprises:
displaying a compartment distribution map for the delivery robot, and highlighting the to-be-used-compartment in the compartment distribution map, wherein the compartment distribution map comprises a plurality of item storage compartments of the robot and a display position of each of the item storage compartments in the compartment distribution map corresponds to an actual spatial position of the item storage compartment.

19. The storage medium according to claim 18, wherein the highlighting the to-be-used-compartment in the compartment distribution map comprises at least one of the following operations:
displaying the to-be-used-compartment in the compartment distribution map in a preset color;
displaying a preset identifier at a preset position corresponding to the to-be-used-compartment in the compartment distribution map;
displaying the to-be-used-compartment in the compartment distribution map in a preset form, wherein the preset form comprises a preset shape and/or a preset size; and
displaying the to-be-used-compartment in the compartment distribution map in a dynamic form, wherein the dynamic form comprises a flashing form and/or a movement along a preset trajectory.

20. The storage medium according to claim 17, wherein the displaying compartment position prompt information corresponding to an actual spatial position of the to-be-used-compartment comprises:
displaying, in the form of text, the compartment position prompt information corresponding to the actual spatial position of the to-be-used-compartment.
